(19) United States
(12) Patent Application Publication
(10) Pub. No.: US 2019/0042521 A1
(43) Pub. Date: Feb. 7, 2019

(54) ASYMMETRICAL EMBEDDED UNIVERSAL SERIAL BUS (EUSB) LINK

(71) Applicant: Intel Corporation, Santa Clara, CA (US)

(72) Inventors: Huimin Chen, Beaverton, OR (US); Karthi Vadivelu, Folsom, CA (US); Abdul Ismail, Beaverton, OR (US); Antonio Cheng, Portland, OR (US); Nobuyuki Suzuki, Portland, OR (US)

(73) Assignee: Intel Corporation, Santa Clara, CA (US)

(21) Appl. No.: 15/905,562

(22) Filed: Feb. 26, 2018

(51) Int. Cl. G06F 13/42; G06F 13/36; G06F 13/40

(52) U.S. Cl. CPC G06F 13/4282; G06F 2213/0042; G06F 13/4068; G06F 13/36

(57) ABSTRACT

A Universal Serial Bus (USB) circuitry of an apparatus is disclosed. In an example, the USB circuitry includes a High Speed (HS) transmitter to transmit data at a first data rate from the apparatus to a component; and a pair of Low Speed/Full speed (LS/FS) receivers to receive data at one or both of a second data rate or a third data rate from the component. In an example, the USB circuitry is to refrain from receiving data from the component at the first data rate.

### BACKGROUND

Using embedded Universal Serial Bus (eUSB) may result in improved signaling techniques, e.g., by providing a lower signal voltage and reduced power consumption, e.g., compared to standard USB2. It may be useful to reduce area and/or cost of implementing an eUSB (e.g., an eUSB2) architecture, e.g., by taking advantage of a nature of data communication between a host and an eUSB component.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 schematically illustrates a device comprising a host communicating with a data generation component using an asymmetrical embedded USB (eUSB) Physical Layer (PHY), according to some embodiments.

FIG. 2 illustrates a block diagram of a USB architecture that may be used (e.g., after appropriate modifications, discussed herein later) in any of USB circuitries of a host and/or a component, according to some embodiments.

FIG. 3 illustrates sections of a USB circuitry, and also illustrates components that may be selectively removed from the USB circuitry, according to some embodiments.

FIG. 4 illustrates a USB circuitry of a host, which lacks a High Speed (HS) transmitter, according to some embodiments.

FIG. 5 illustrates a USB circuitry of a component, which lacks a HS receiver, according to some embodiments.

FIG. 6 schematically illustrates a device comprising a host communicating with a data consumption component using an asymmetrical embedded USB (eUSB) link, according to some embodiments.

FIG. 7 illustrates a flowchart depicting a method for enumerating an asymmetrical eUSB2 component, according to some embodiments.

FIG. 8 illustrates a computer system or a SoC (System-on-Chip), which includes an asymmetrical eUSB2 circuitry, according to some embodiments.

### DETAILED DESCRIPTION

A host may communicate with a component using eUSB architecture, e.g., an eUSB2 architecture. For example, the host and the component may communicate user data at a High Speed (HS) data rate, where the user data may also be referred to as HS data. Also, the host and the component may communicate control data at a Low Speed (LS) data rate and/or a Full Speed (FS), where the control data may also be referred to as LS/FS data. Merely as an example, the LS data rate may be about 1.5 Mbit/s, the FS data rate may be about 12 Mbit/s, and the HS data rate may be about 480 Mbit/s (or even higher, depending on the applications and the negotiation between the host and component).

In an example, communication of user data, which may be generally transmitted as HS data, may be asymmetrical in nature. For example, if the component is a data generation component, then the component may solely or mainly transmit user data to the host, and the host need not transmit any HS data, or any significant amount of HS data to the component. On the other hand, if the component is a data consumption component, then the component may solely or mainly receive user data from the host, and the component need not transmit any HS data, or any significant amount of HS data to the host.

In some embodiments, the eUSB2 Physical Layer (PHY) of the host and/or the component may take advantage of this asymmetrical nature of transmission of user data. For example, if the component is a data generation component (e.g., the component solely or mainly transmitting user data to the host), then the eUSB2 PHY of the host may lack a HS transmitter and/or the eUSB2 PHY of the component may lack HS receiver. On the other hand, if the component is a data consumption component (e.g., the host solely or mainly transmitting user data to the component), then the eUSB2 PHY of the host may lack a HS receiver and/or the eUSB2 PHY of the component may lack HS transmitter. Such selective lack of HS transmitters/receivers in the host and/or the components may result in savings in terms of area, cost of manufacturing, reduced circuit complexity and power consumption, etc. Other technical effects will be evident from the various embodiments and figures.

Furthermore, an eUSB2 port, unlike a standard USB port, is not a general-purpose port in which any component may be plugged. For example, an eUSB2 port of the host is dedicated to be used for a specific type of component (e.g., if an eUSB2 port is for a web-camera, a display may not be plugged in the port). Thus, the loss of HS transmission or HS reception capability (e.g., due to the lack of the HS transmitter or the HS receiver, respectively) in an eUSB2 PHY of the host may not adversely affect the performance or universality of the eUSB2 PHY.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front”, “back,” “top,” “bottom,” “over,” “under,” and the like in the description and in the claims, if any, are used for descriptive purposes and not necessarily for describing permanent relative positions.

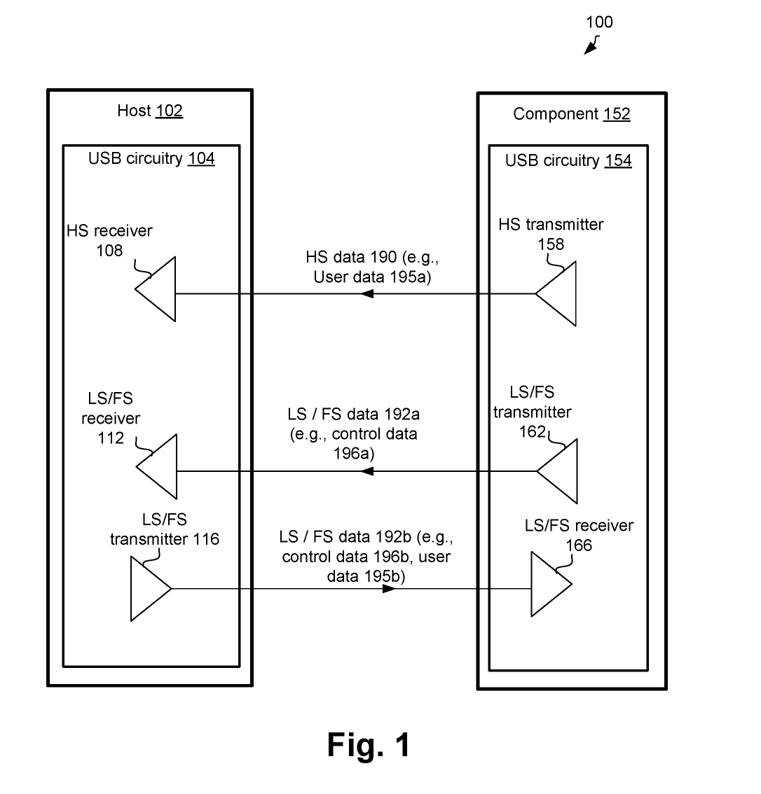

FIG. 1 schematically illustrates a device 100 comprising a host 102 communicating with a data generation component 152 using an asymmetrical embedded USB (eUSB) Physical Layer (PHY), according to some embodiments. The host 102 may be any appropriate host, e.g., a computing device, a System on a Chip (SOC), and/or the like.

The component 152 may be any appropriate component that generates data and transmits data to the host 102. Examples of the component 152 may include, but not limited to, a camera, a webcam, a thermal sensor, etc., which generates data (e.g., user data 195a) based on sensing external environment (e.g., capturing images, videos, temperature data, etc.), and transmits the user data 195a to the host 102. The user data 195a may be transmitted from the component 152 to the host 102 as HS data 190. In another example, the component 152 may be a touch pad sensor or a touch display that may sense a touch of an element (e.g., a user's finger, a stylus, etc.), and transmit the data associated with the touch (e.g., user data 195a) to the host 102 as HS data 190. In some embodiments, the component 152 may be any appropriate component that may generate user data 195a, and transmit the user data 195a to the host 102 as HS data 190. The component 152 may also be referred to as a user data generation component, or as a data generation component.

In some embodiments, the component 152 may be embedded within the device 100. For example, the component 152 may be included within (e.g., non-removably attached) to the device 100. As an example, a mouse, a key board, an external display, etc. of the device 100 may be removably attached to the device 100 (e.g., a user may easily plug or unplug these devices to or from the device 100, as and when desired). In contrast, the component 152 may be non-removably attached to the device 100, such that a user may generally not plug or un-plug the component to or from the device 100 during a normal course of operation of the device 100 (e.g., of course, the user can plug or unplug the component 152 during a maintenance or troubleshooting of the device 100, during installation of a new component 152, during removal of a defective component 152, etc.).

In some embodiments, the host 102 may comprise USB circuitry 104, and the component 152 may comprise USB circuitry 154, where the USB circuitries 104, 154 may be eUSB circuitries (e.g., eUSB2 circuitries). In some embodiments, communication between the host 102 and the component 152 may be via eUSB2 links. Because the component 152 may be included within (e.g., non-removably attached) to the device 100, an eUSB (e.g., eUSB2) architecture may be employed for communication between the component 152 and the host 102. For example, the eUSB2 circuitry 104 of the host 102, unlike a standard USB circuitry, may not be a general-purpose circuitry to which any component may be plugged. For example, an eUSB2 port associated with the eUSB2 circuitry 104 of the host 102 may be dedicated to be used for the specific type of component 152 (e.g., if the component 152 is for a web-camera, an embedded display or a memory may not be plugged in the port).

However, in some other examples, any other USB and/or eUSB protocol (or any other appropriate communication protocol) may also be used for communication between the host 102 and the component 152.

Using an eUSB2 may result in improved signaling techniques, e.g., by providing a lower signal voltage and reduced power consumption, e.g., compared to standard USB2. The signaling techniques described herein can be used to support the standard USB2.0 operation at the protocol level. Furthermore, the signaling techniques described herein may use simplified physical layer architecture, as compared to the standard USB2.0 physical layer architecture. The simplified physical layer architecture disclosed herein can support LS operation, FS operation, or HS operation. During High-Speed operation, the link may be operated using low-swing differential signaling, for example, 0.2 Volt differential signaling, e.g., as opposed to 0.4 Volt differential signaling used in standard USB2. During Low-Speed or Full-Speed operation, the PHY architecture disclosed herein may enable a use of a fully digital communication scheme. For example, the PHY architecture may use 1 Volt circuitry, as opposed to the 3.3 Volts signaling used in standard USB2.

In some embodiments, data transmission between the host 102 and the component 152 may be asymmetrical in nature. For example, bulk or major portion of the data transmission between the host 102 and the component 152 may be the user data 195a, transmitted as HS data 190 from the component 152 to the host 102. The host 102 and the component 152 may also communicate control data 196a, 196b, and the host 102 may also transmit some amount of user data 195b to the component 152 (e.g., the volume of user data 195b from the host 102 to the component 152 may be substantially less than the volume of user data 195a from the component 152 to the host 102). For example, the host 102 may transmit control data 196b to the component 152, and may receive control data 196a from the component 152. The control data 192a, 192b may be, in an example, less in volume than the user data 195a. The control data 192a, 192b may comprise data associated with configuring the component 152, configuring the USB circuitry 154, controlling the component 152, etc.

In some embodiments, the control data 196b and/or the user data 195b from the host 102 to the component 152 may be transmitted as LS/FS data 192b. In some embodiments, the control data 196a from the component 152 to the host 102 may be transmitted as LS/FS data 192a (although in some other embodiments, at least a part of the control data 192a may also be transmitted as HS data 190, e.g., depending on an available bandwidth of a HS link carrying the HS data 190).

In some embodiments, the user data 195a may be relatively more time sensitive than the control data 192a, 192b. Also, the user data 195a may use higher bandwidth for transmission than the control data 192a, 192b, and user data 195b (e.g., the volume of user data 195a may be substantially higher than the volume of the control data 192a, 192b, and the user data 195b). Accordingly, in some embodiments, the user data 195a may be transmitted using a HS link as HS data 190; the control data 196a may be transmitted using Low Speed and/or Full Speed (LS/FS) links as LS/FS data 192a; and the control data 196b and/or the user data 195b may be transmitted using LS/FS links as LS/FS data 192b.

In some embodiments, if an available bandwidth of a HS link transmitting HS data 190 is sufficient, the at least portions of the control data 196b may also be transmitted from the component 152 to the host 102 as HS data 190.

As the names suggests, the HS link may operate at relatively high speed (e.g., the HS data rate may be about 480 Mbit/s, or higher); and the LS/FS link may operate at about 1.5 Mbit/s (e.g., during LS operation), and/or at a data rate of about 12 Mbit/s (e.g., during FS operation).

The USB circuitry 104 of the host 102 may include a HS receiver 108 to receive HS data 190 from the component 152 via a HS link, e.g., at a HS data rate. The USB circuitry 104 of the host 102 may also include a LS/FS receiver 112 (which may comprise a pair of single ended receivers, as discussed herein in further details) to receive LS/FS data 192a from the component 152 via a LS/FS link. The USB circuitry 104 of the host 102 may also include a LS/FS transmitter 116 (which may comprise a pair of single ended transmitters, as discussed herein in further details) to transmit LS/FS data 192b to the component 152 via a LS/FS link.

The USB circuitry 154 of the component 152 may include a HS transmitter 158 to transmit HS data 190 to the host 102 via the HS link at the HS data rate. The USB circuitry 154 of the component 152 may also include a LS/FS receiver 166 (which may comprise a pair of single ended receivers, as discussed herein in further details) to receive LS/FS data 192b from the host 102 via the LS/FS link. The USB circuitry 154 of the component 152 may also include a LS/FS transmitter 162 (which may comprise a pair of single ended transmitters, as discussed herein in further details) to transmit LS/FS data 192a to the host 102 via the LS/FS link.

In some embodiments and as will be discussed in further details herein, the USB circuitry 104 of the host 102 lacks a HS transmitter (and associated circuitries), and the USB circuitry 154 of the component 152 lacks a HS receiver (and associated circuitries). This is due to a lack of HS user data to be transmitted from the host 102 to the component 152. Put differently, the host 102 merely transmits time-insensitive and/or low volume control data 192b and/or low volume user data 195b to the component 152—as the host 102 does not need to transmit high volume user data to the component 152, the USB circuitries 104 and 154 may not respectively need a HS transmitter and a HS receiver. Furthermore, as the component 152 is an embedded component of the device 100, in an example, the USB circuitry 104 may be used solely for coupling to the component 152, or a replacement of the component 152 (e.g., the USB circuitry 104 is not a general-purpose circuitry for coupling any type of component). Thus, the USB circuitry 104 may not be a generic USB circuitry, but rather a dedicated USB circuitry (e.g., eUSB2 circuitry) for coupling specifically to the component 152. Hence, the USB circuitry 104 does not need a HS transmitter to transmit HS data to the component 152, and similarly, the USB circuitry 154 does not need a HS receiver to receive HS data from the host 102. Thus, a lack of HS transmitter (and associated circuitries) in the USB circuitry 104 of the host 102 and a lack of a HS receiver in the USB circuitry 154 of the component 152 may not have any adverse effect on the operation or universality of the host 102 and/or the component 152, yet saving area, complexity and/or cost associated with the host 102 and/or the component 152.

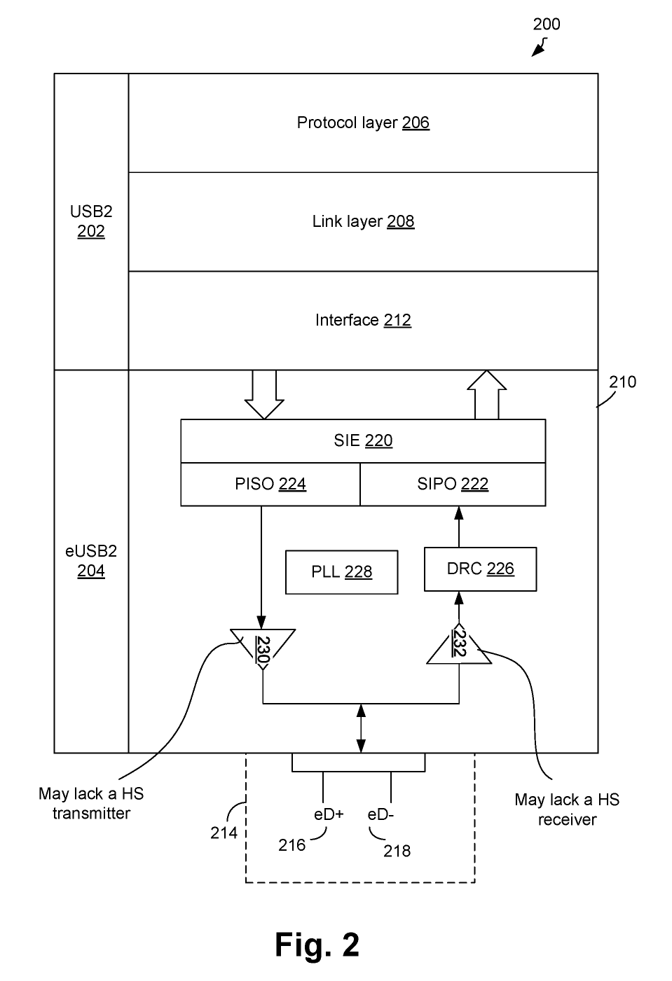

FIG. 2 is a block diagram of a USB architecture 200 (e.g., an eUSB2 architecture) that may be used (e.g., after appropriate modifications, discussed herein later) in any of the USB circuitries 104, 154 of the host 102 and/or the component 152, according to some embodiments.

The architecture 200 may be used in any suitable electronic device, including desktop computers, laptop computers, tablets, mobile phones, the host 102, the component 152, among others. The architecture 200 may contain a standard USB2.0 segment 202 and an eUSB2 segment 204 in accordance with some embodiments. The standard USB2.0 segment 202 may include a protocol layer 206 and a link layer 208. The protocol layer 206 may be used for managing the transfer of information between a device and a host. For example, the protocol layer 206 may be used to determine how to structure information packets. The link layer 208 may be used for creating and maintaining a channel of communication (or link) with another USB architecture of another component. The link layer 208 may also control the flow of information and power management status of the link. In embodiments, both the protocol layer 206 and the link layer 208 may operate in accordance with standard USB2.0 communication protocols.

The eUSB2 segment 204 may contain a physical layer (PHY) 210. The physical layer 210 may interface with the link layer 208 through any suitable interface 212, such as a USB 2.0 Transceiver Macrocell Interface (UTMI), and UTMI with extensions (UTMI+), among others.

The physical layer 210 may include a pair of eUSB2 data lines 214, referred to herein as eD+ 216 and eD− 218. The data lines 214 may be used to transmit signals between an upstream port and a downstream port. Depending on the particular operating mode, the physical layer 210 may be configured to transmit data on the data lines 114 using differential signaling, single ended digital communications, or some combination thereof.

For example, while operating in HS or high speed, differential signaling may be used to transmit HS data. Single-ended digital communications may be used to transmit LS/FS data. While operating in LS or FS, single-ended digital communications may be used to transmit LS/FS data. The functions and behaviors of eD− and eD+ may vary depending on a desired data rate.

The physical layer 210 may also include a Serial Interface Engine (SIE) 220 for translating USB information packets to be used by the protocol layer 206. The Serial Interface Engine 220 includes a Serial-In, Parallel-Out (SIPO) block 222 for converting incoming serial data received via the signal lines 214 into parallel data for transmitting to the link layer 208. The Serial Interface Engine 220 may also include a Parallel-In, Serial-Out (SIPO) block 222 for converting outgoing parallel data received from the link layer 208 into serial data for transmission onto the signal lines 214. The physical layer 210 can also include a Data Recovery Circuit (DRC) 226 and a Phased Locked Loop (PLL) 228 for recovering data, or transmitting data via the signal lines 214.

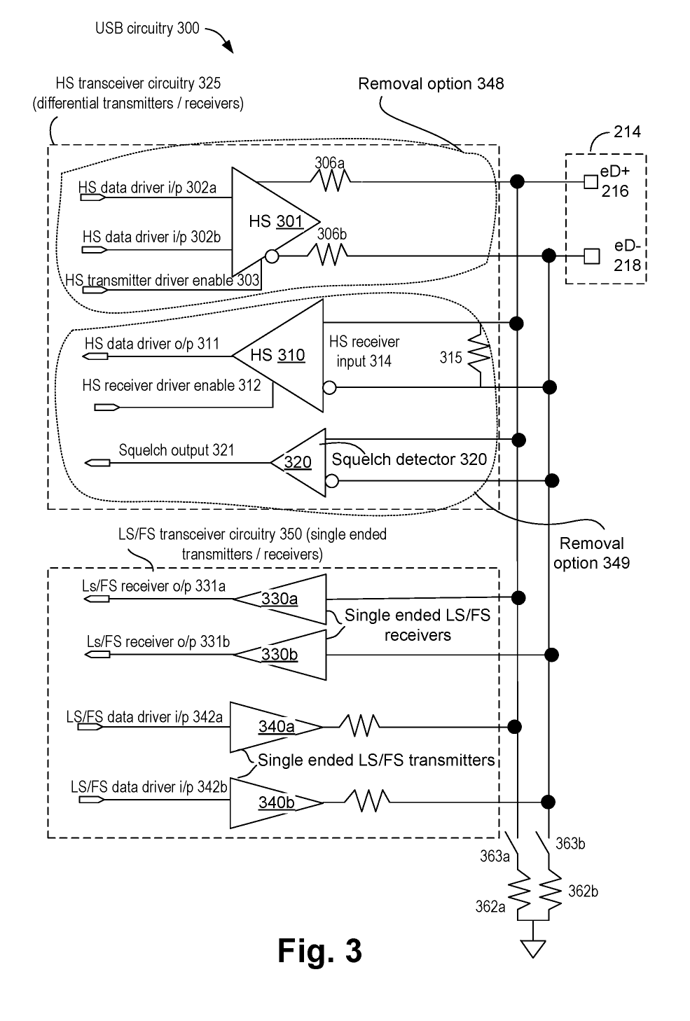

The physical layer 210 may include a number of transmitters 230 and receivers 232 for controlling the signals lines 214. For the sake of simplicity, a single transmitter 230 and receiver 232 pair are illustrated in FIG. 2. However, it will be appreciated that the physical layer 210 may include any suitable number of transmitters 230 and receivers 232 used to implement the various embodiments described herein. The transmitters 230 and receivers 232 are discussed in further details herein later. In some embodiments, the transmitters 230 may lack a HS transmitter, or the receivers 232 may lack a HS receiver, e.g., based on a component or host in which the USB architecture 200 is implemented, e.g., as alluded in FIG. 1 and as also discussed herein later. The physical layer 210 is described further in relation to FIG. 3.

FIG. 3 illustrates sections of a USB circuitry 300, and also illustrates components that may be selectively removed from the USB circuitry 300, according to some embodiments. As discussed in further details herein, the USB circuitry 300 may be used, after selective removal of one or more components, as the USB circuitry 104 of the host 102 of FIG. 1, or as the USB circuitry 154 of the component 152 of FIG. 1. In an example, the USB circuitry 300 illustrates components that may be present (or absent) in a PHY of an eUSB2 arrangement, e.g., present in the PHY 210 of FIG. 2.

In some embodiments, the USB circuitry 300 comprising the physical layer has High-Speed (HS), Low-Speed (LS), and Full-Speed (FS) capability. In some embodiments, the HS, FS, and LS data rates correspond to the data rates specified by the USB2.0 protocol. For example, during LS operation, the PHY may provide a data rate of approximately 1.5 Mbit/s, during FS operation the PHY may provide a data rate of approximately data rate of 12 Mbit/s, and during HS operation the PHY may provide a data rate of approximately 480 Mbit/s or higher.

The eUSB2 PHY of the USB circuitry 300 may include a LS/FS transceiver circuitry 350, and a HS transceiver circuitry 325. In some embodiments, the USB circuitry 300 may include a pair of pull-down resistors 362a, 362b, which may be used for host and component to maintain the eUSB2 signal lines to ground during idle state. The resistance of the resistors 362a, 362b may be relatively high, and the resistors 362a, 362b may be coupled to eUSB2 signal lines 214 (e.g., comprising the eD+ 216 and eD− 218 signal lines) via respective switches 363a and 363b. The switches may be on when the eUSB2 PHY of the USB circuitry 300 is in a low power state, e.g., to maintain the link in idle state.

The LS/FS transceiver 350 and the HS transceiver 325 are communicatively coupled to the eUSB2 signal lines 214, which may include the eD+ 216 and eD− 218. The HS transceiver 325 and the LS/FS transceiver 350 may be configured to selectively take control of the signal lines 214, e.g., depending on the data rate capabilities of the upstream device connected to the eUSB2 PHY of the USB circuitry 300.

The LS/FS transceiver 350 may include a pair of single-ended digital transmitters 340a, 340b, and a pair of single-ended digital receivers 330a, 330b. These components act as the input and output, respectively, for single-ended signaling. In single-ended signaling, each of the signal lines eD+ 216 and eD− 218 can transmit independent signal information. This may be in contrast to standard USB2.0 implementation, in which LS/FS operations use differential signaling. In differential signaling, information is transmitted through two complementary signals transmitted on the pair of signal lines eD+ 216 and eD− 218. The translation of the physical signals transmitted over the signal lines 214 into binary signal data may be accomplished using any suitable techniques, such as Non-return-to-zero, inverted (NRZI).

The LS/FS transceiver 350 may be fully digital, meaning that the analog components typically present for USB2.0 LS/FS circuitry, such as operational amplifiers and current sources, are eliminated. The single-ended digital transmitters 340a, 340b and the single-ended digital receivers 330a, 330b may be digital CMOS (Complementary Metal-Oxide-Semiconductor) components that operate with a signaling voltage of about 1.0 Volts, e.g., as compared to the standard 3.3 Volt signaling for USB2. Low-speed/Full-speed idle state (SE0) may be maintained by the pull-down resistors 362 implemented at the downstream port. To ensure a swift transition to idle state, the port may drive the bus to SE0 before disabling the transmitters.

The HS transceiver 325 of the eUSB2 PHY of the USB circuitry 300 may be an analog transceiver configured for low swing differential signaling. For example, the HS transceiver 325 may operate with a signaling voltage of 0.2 Volts, as compared to the 0.4 Volts used in USB2, and thus, a reduced power consumption may be achieved during data transmission relative to USB2.

In some embodiments, the HS transceiver 325 may include a High-Speed transmitter 301 for data transmission, a High-Speed receiver 310 for data reception, and a squelch detector 320 for detection of the start and end of a packet (e.g., whether the link is at HS active state, HS idle state, etc.). Additionally, in some embodiments, the HS transceiver 325 may also include an HS receiver termination 315, e.g., to minimize the signal reflection at the receiver 310 leading to improved signal integrity.

During the HS operating mode, when the HS transceiver 325 is enabled, the PHY may communicate HS data (e.g., HS 190 of FIG. 1) using differential signaling, and may also transmit LS/FS data (e.g., LS/FS data 192a, 192b of FIG. 1) using single-ended communications.

The HS transceiver 325 and LS/FS transceiver 350 may be controlled by the link layer 208 of FIG. 2, which may interface with the PHY of FIG. 3 through the interface 212. Various data and control lines from the interface 212 may be coupled to the transceivers 325 and 350. For example, as shown in FIG. 3, enable signals 303, 312 may be are used to selectively enable the HS transmitter 301 and HS receiver 310. Although not illustrated in FIG. 3 for purposes of illustrative clarity, similar enable signal lines may also be used to selectively enable the LS/FS receivers 330a, 330b, and similar enable signal lines may also be used to selectively enable the LS/FS transmitter 340a, 340b.

Complementary driver inputs 302a and 302b are coupled to the HS transmitter 301, for driving the HS transmitter 301 to output data to the signals lines 214 (e.g., via resistors 306a, 306b). A receiver output 311 is coupled to the HS receiver 310 for receiving data transmitted to the USB arrangement 300 via the signals lines 214. The squelch detector 320, upon detecting the start of HS data packet, may disable the single ended receivers 330a, 330b, enable the HS receiver 310, and optionally enable the receiver termination 315.

Thus, for the HS receiver 310 to be enabled and the single ended receivers 330a, 330b to be disabled (e.g., upon detecting the start of HS data packet), the squelch detector 320 performs a critical role. Put differently, for proper operation of the HS receiver 310, the squelch detector 320 has to be present in the USB circuitry 300. However, the squelch detector 320 may not play a major role in the operation of the HS transmitter 301.

Positive and negative receiver outputs 331a and 331b are coupled to the LS/FS receivers 330a and 330b, respectively, for receiving data transmitted to the USB circuitry 300 via the signals lines 214. Positive and negative driver inputs 342a and 342b are coupled to the LS/FS transmitters 340a and 340b, respectively, for driving the LS/FS transmitters 340a, 340b to output data and/or control signals (e.g., control signals 192a, 192b) to the signals lines 214.

The HS transceiver 325 is configured for half-duplex operation (e.g., when the HS transmitter 301 is transmitting over the signal lines 214, the signal lines 214 cannot be used for reception; and when the HS receiver 310 is receiving over the signal lines 214, the signal lines 214 cannot be used for transmission). The LS/FS transceiver 350 are configured for full-duplex operation.

In embodiments, the device port (not shown) may have an eUSB2 interface with a physical layer substantially similar to the physical layer illustrated in FIG. 3. In such an embodiment, the host and device both use the eUSB2 protocol. In embodiments, the device port may be a standard USB2.0 port with a standard USB2.0 physical layer. In such an embodiment, a repeater may be used to translate the eUSB2 signals sent from the host to standard USB2.0 signals. For example, the repeater may be configured to translate signals, such as device connect, device disconnect, data rate negotiation, and the like. The repeater may also be used to recondition the voltages of the eUSB2 signals to the voltages used in standard USB2.0.

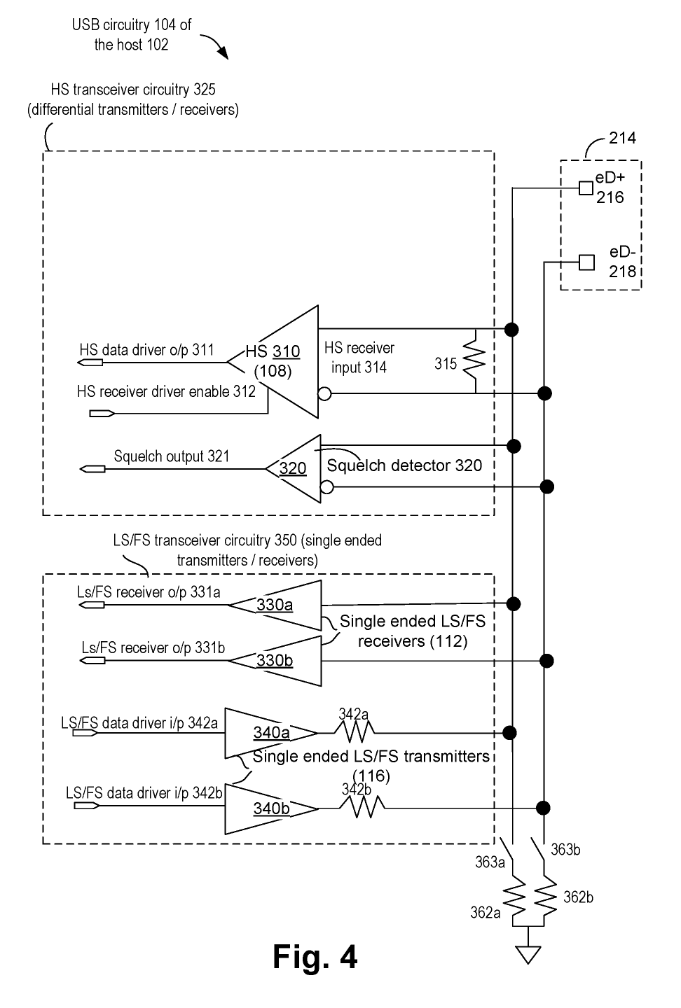

Referring now to FIGS. 1 and 3, in some embodiments, when the USB circuitry 300 is implemented in the host 102, the host 102 may receive HS data 190 from the component 152, but may not need to transmit HS data to the component 152. Accordingly, the host 102 may have the HS receivers 310 (which may correspond to the receiver 109 depicted in FIG. 1), but need not have the HS transmitters 301. Thus, as illustrated in FIG. 3, a removal option 348 may be associated with removal of the HS transmitters 301 (e.g., if the USB circuitry 300 is implemented in the host 102 as the USB circuitry 104). For example, FIG. 4 illustrates the USB circuitry 104 of the host 102, which lacks a HS transmitter, according to some embodiments (e.g., the USB circuitry 104 of FIG. 4 is the USB circuitry 300 of FIG. 3, with option 348 exercised to remove the HS transmitter 301). Thus, the USB circuitry 104 of FIG. 4 includes the HS receiver 310, which corresponds to the HS receiver 108 of FIG. 1. As the squelch detector 320 has to be present in the USB circuitry for proper operation of the HS receiver 310, the squelch detector 320 may be present in the USB circuitry 104 of FIG. 4.

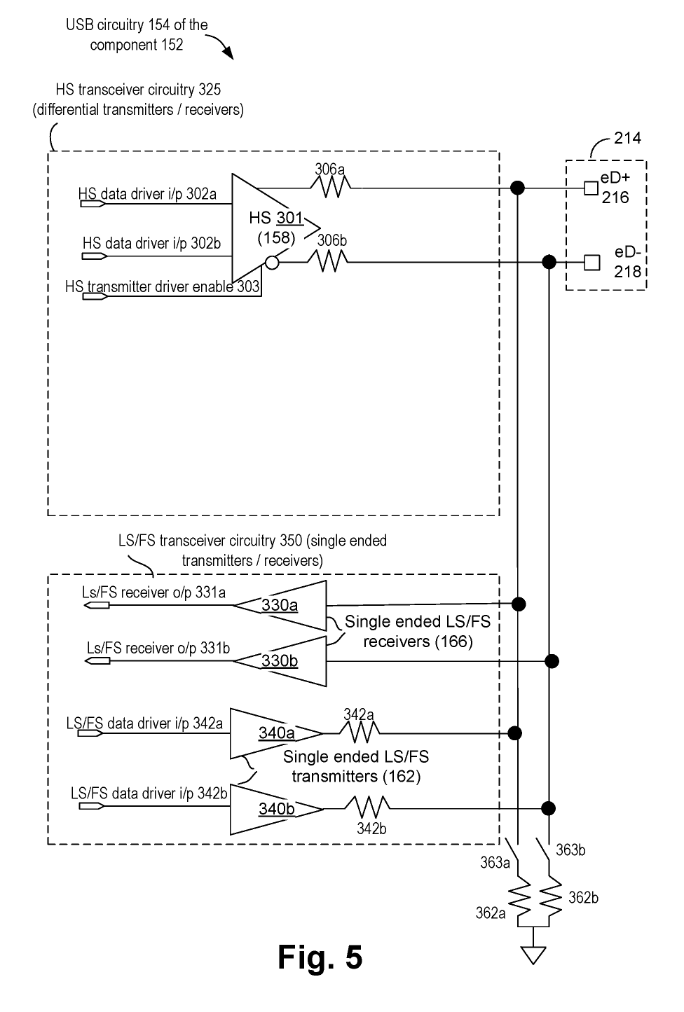

Referring again to FIGS. 1 and 3, in some embodiments, when the USB circuitry 300 is implemented in the component 152, the component 152 may transmit HS data 190 to the host 102, but may not need to receive HS data from the host 102. Accordingly, the component 152 may have the HS transmitters 310 (which may correspond to the transmitter 158 depicted in FIG. 1), but need not have the HS receiver 310. Thus, as illustrated in FIG. 3, a removal option 349 may be associated with removal of the HS receivers 310. For example, FIG. 5 illustrates the USB circuitry 154 of the component 152, which lacks a HS receiver, according to some embodiments (e.g., the USB circuitry 154 of FIG. 5 is the USB circuitry 300 of FIG. 3, with option 349 exercised to remove the HS receiver 310 and the squelch detector 320). Thus, the USB circuitry 154 of FIG. 5 includes the HS transmitter 301, which corresponds to the HS transmitter 158 of FIG. 1. Also, as the squelch detector 320 may not play a major role in the operation of the HS transmitter 301, the squelch detector 320 may also be removed from the USB circuitry 154 of FIG. 5.

It may be noted that although various components in FIGS. 4 and 5 are labeled using the same labels, the components of FIG. 4 are present in the USB circuitry 104 of the host 102, and the components of FIG. 5 are present in the USB circuitry 154 of the component 152. For example, the single ended LS/FS receivers 330a, 330b are labeled similarly in FIGS. 4 and 5. However, as discussed herein above, the LS/FS receivers 330a, 330b of FIG. 4 are present in the USB circuitry 104 of the host 102, and correspond to the LS/FS receiver 112 of FIG. 1. On the other hand, the LS/FS receivers 330a, 330b of FIG. 5 are present in the USB circuitry 154 of the component 152, and correspond to the LS/FS receiver 166 of FIG. 1.

Similarly, the LS/FS transmitters 340a, 340b of FIG. 4 are present in the USB circuitry 104 of the host 102, and correspond to the LS/FS transmitter 116 of FIG. 1. On the other hand, the LS/FS transmitter 340a, 340b of FIG. 5 are present in the USB circuitry 154 of the component 152, and correspond to the LS/FS transmitter 162 of FIG. 1.

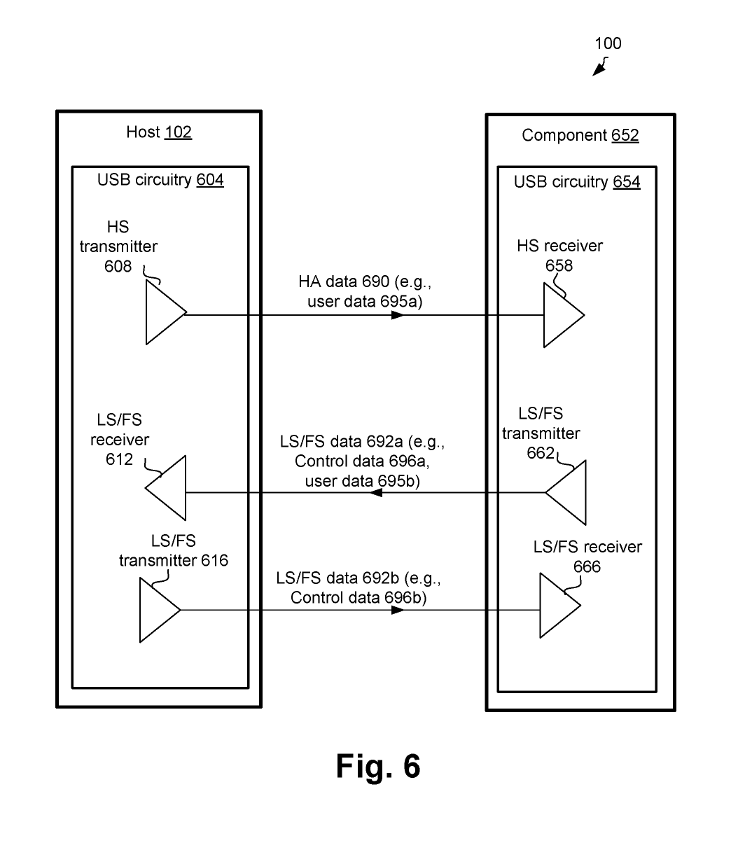

FIG. 6 schematically illustrates the device 100 comprising the host 102 communicating with a data consumption component 652 using asymmetrical embedded USB (e.g., eUSB2) link, according to some embodiments. For example, the component 152 of FIG. 1 is a data generation component that generated HS data 190 (e.g., user data 195a) to be transmitted to the host 102 using HS link. In contrast, the component 652 of FIG. 6 is a data consumption component that receives user data 695 (e.g., as HS data 690) from the host 102 over a HS link. Examples of data consumption component 652 may be a display coupled to (e.g., embedded or non-removably attached to) the host 102, an audio speaker coupled to (e.g., non-removably attached to) the host 102, etc.

In FIG. 6 the host 102 and the component 652 comprises USB circuitries 504 and 654, respectively. Similar to FIG. 1, in FIG. 6 the USB circuitry 604 comprises LS/FS receiver 612 and LS/FS transmitter 616, and the USB circuitry 654 comprises LS/FS receiver 666 and LS/FS transmitter 662. The LS/FS transmitters and receivers are for communication of LS/FS data 692a, 692b, e.g., which may comprise control data 696a, 696, user data 695b, etc., between the host 102 and the component 652.

As the flow of user data 695, 695b may be asymmetrical in nature (e.g., user data 695a flows solely or mainly from the host 102 to the component 652, and zero or very small amount of user data 695b flows form the component 652 to the host 102), the USB circuitry 604 of the host may include a HS transmitter 608, but may lack a HS receiver. Similarly, the USB circuitry 654 of the component 652 may include a HS receiver 658, but may lack a HS transmitter.

Merely as an example, the USB circuitry 604 of FIG. 6 may be at least in part similar to the USB circuitry 154 of the component 152 of FIG. 5, and the USB circuitry 654 of FIG. 6 may be at least in part similar to the USB circuitry 104 of the host 102 of FIG. 4. Put differently, the role, structure and/or configuration of the host 102 and the component 152 of FIGS. 1, 4 and 5 may be opposite of those of the host 102 and the component 652 of FIG. 6.

As discussed with respect to FIGS. 1-6, an eUSB2 PHY may take advantages of asymmetrical nature of traffic between a host and a component. For example, based on a direction of flow of high volume user data, either a HS transmitter, or a HS receiver and a squelch detector may be opportunistically removed from the eUSB2 PHY, without sacrificing any performance. Removal of such components may result in savings of area, cost, circuit complexity, etc.

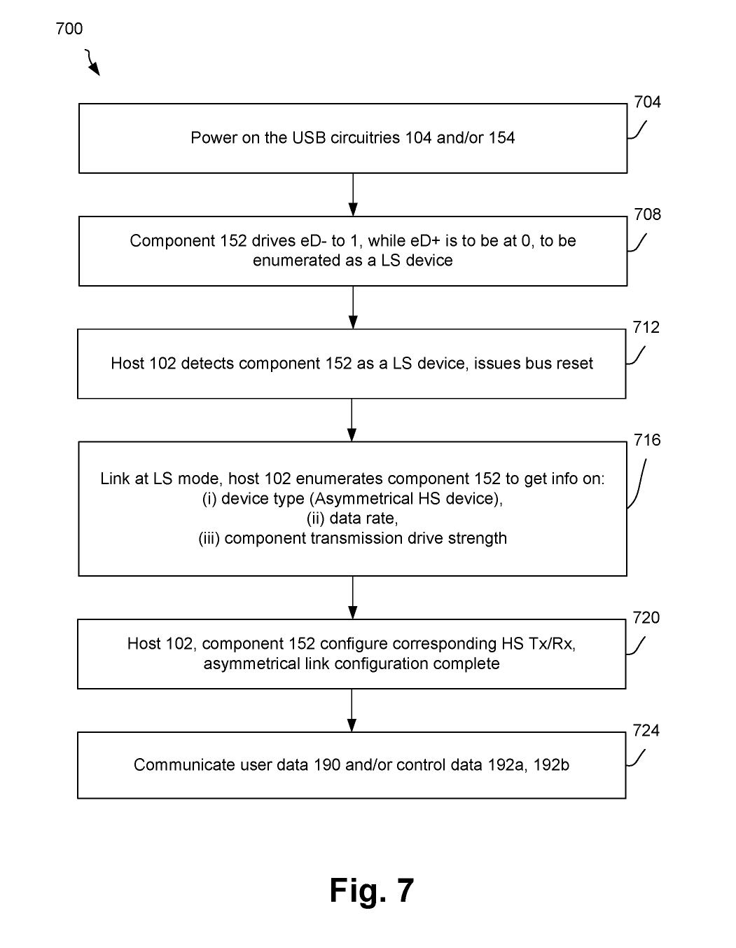

FIG. 7 illustrates a flowchart depicting a method 700 for enumerating an asymmetrical eUSB2 component, according to some embodiments. Although the blocks in the flowchart with reference to FIG. 7 are shown in a particular order, the order of the actions can be modified. Thus, the illustrated embodiments can be performed in a different order, and some actions/blocks may be performed in parallel. Some of the blocks and/or operations listed in FIG. 7 may be optional in accordance with certain embodiments. The numbering of the blocks presented is for the sake of clarity and is not intended to prescribe an order of operations in which the various blocks must occur.

The method 700 may be applicable to the host 102/component 152 illustrated in FIG. 1, and may also be applicable to the host 102/component 652 illustrated in FIG. 6. Merely for the sake of simplicity, the discussion of the method 700 herein below is done with respect to the host 102/component 152 illustrated in FIG. 1, although the principles of the method 700 may also be applicable to the host 102/component 652 illustrated in FIG. 6.

In some embodiments, the method 700 commences at 704, when one or both the USB circuitries 104 or 154 are powered on. Powering on one or both the USB circuitries 104 or 154 triggers the enumeration process discussed in FIG. 7.

At 708, the component 152 may drive the eD− signal line 216 (e.g., see FIGS. 3-5) to 1, while the eD+ signal line 218 remains at 0. The component 152 may drive the eD− signal line 216 to 1 and the eD+ signal line 216 to 0, e.g., to initially identify itself as a LS device to the host 102. Accordingly, at 712, the host 102 detects the component 152 as a LS device, and issues a bus reset.

The operations at 716 occurs while the USB circuitries 104, 154 are in the LS mode, e.g., communication between the two circuitries occur via single ended LS/FS transmitters using LS data rate. At 716, when the link is at the LS mode, the host 102 again enumerates the component 152 to get various information about the component 152. For example, the component 152 provides a device type, where the component 152 now identifies itself as an asymmetrical HS device (e.g., identifies that the component 152 has a HS transmitter, but lacks a HS receiver). A data rate supported by the component 152 (e.g., HS data arte, FS data rate, LS data rate, etc.) may also be supplied to the host 102. The component 152 may also negotiate a transmission drive strength, which may be based on a physical distance of the link between the circuitries 104, 154, quality of the link, a Quality of Service (QoS) desired, power constraints, etc.

At 720, the host 102 and the component 152 respectively configure their HS receiver and HS transmitter, and complete the asymmetrical HS link configuration. At 724, the host 102 and the component 152 communicate HS data 190 (e.g., user data 195a) at a HS data rate, and LS/FS data 192a, 192b at one or both of LS or FS data rate.

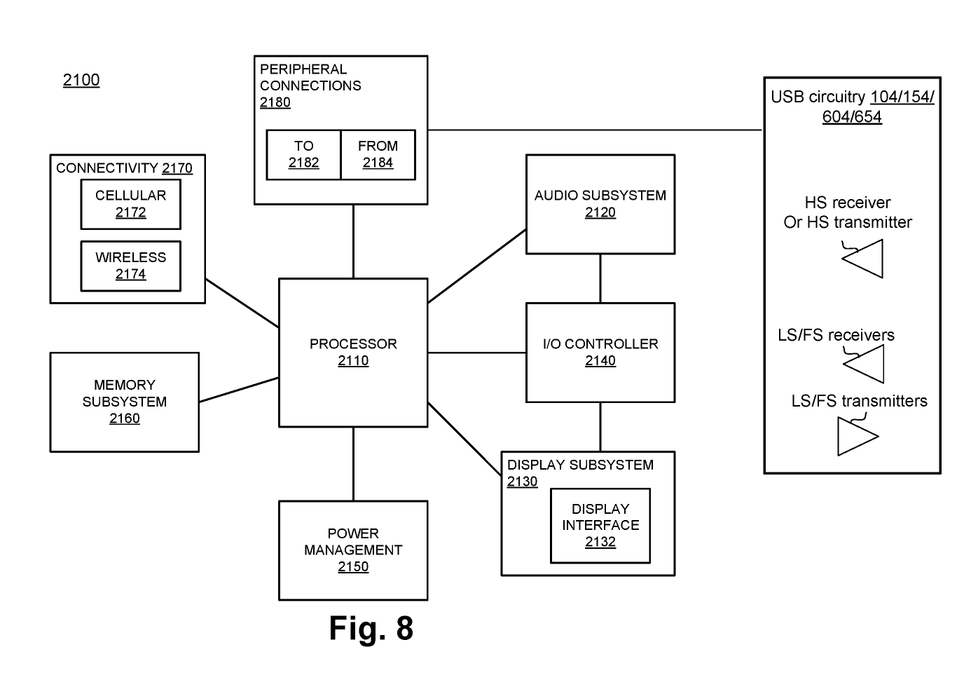

FIG. 8 illustrates a computer system or a SoC (System-on-Chip) 2100, which includes an asymmetrical eUSB2 circuitry, according to some embodiments. It is pointed out that those elements of FIG. 8 having the same reference numbers (or names) as the elements of any other figure can operate or function in any manner similar to that described, but are not limited to such.

In some embodiments, computing device 2100 represents an appropriate computing device, such as a computing tablet, a mobile phone or smart-phone, a laptop, a desktop, an IOT device, a server, a set-top box, a wireless-enabled e-reader, or the like. It will be understood that certain components are shown generally, and not all components of such a device are shown in computing device 2100.

In some embodiments, computing device 2100 includes a first processor 2110. The various embodiments of the present disclosure may also comprise a network interface within 2170 such as a wireless interface so that a system embodiment may be incorporated into a wireless device, for example, cell phone or personal digital assistant.

In one embodiment, processor 2110 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100. In one embodiment, computing device 2100 includes a clock generation subsystem 2152 to generate a clock signal.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, the computing device 2100 may be used to implement the host 102, the component 152, and/or the component 652. For example, the computing device 2100 includes one or more of USB circuitries 104, 154, 604, 654, e.g., based on a host or component that the computing device 2100 represents. For example, the USB circuitry of the computing device 2100 comprises a HS receiver or a HS transmitter, e.g., as discussed with respect to FIGS. 1-7. The USB circuitry of the computing device 2100 comprises single ended LS/FS receivers and single ended LS/FS transmitters.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A Universal Serial Bus (USB) circuitry of an apparatus, the USB circuitry comprising:
a High Speed (HS) transmitter to transmit data at a first data rate from the apparatus to a component; and
a pair of Low Speed/Full speed (LS/FS) receivers to receive data at one or both of a second data rate or a third data rate from the component, wherein the second or third data rate is slower than the first data rate,
wherein the USB circuitry is to refrain from receiving data from the component at the first data rate.

2. The USB circuitry of claim 1, further comprising:
a pair of single-ended LS/FS transmitters to transmit data at one of the second data rate or the third data rate to the component.

3. The USB circuitry of claim 1, wherein the first data rate is at least about 480 Mega bits per second (Mbit/s), the second data rate is about 12 Mbit/s, and the third data rate is about 1.5 Mbit/s.

4. The USB circuitry of claim 1, wherein the USB circuitry is an embedded USB2.0 (eUSB2) circuitry.

5. The USB circuitry of claim 1, wherein the HS transmitter employs differential signaling, and each of the pair of Low Speed/Full speed (LS/FS) receivers employs single ended signaling.

6. The USB circuitry of claim 1, further comprising:
a controller to:
initially enumerate the USB circuitry as a LS USB circuitry, in response to the USB circuitry being coupled to the component, and
subsequently enumerate the USB circuitry as an asymmetrical HS USB circuitry.

7. The USB circuitry of claim 1, wherein the USB circuitry lacks a HS receiver to receive data from the component.

8. The USB circuitry of claim 7, wherein the USB circuitry lacks a squelch detector associated with a HS receiver.

9. The USB circuitry of claim 1, wherein a Physical Layer (PHY) of the USB circuitry lacks a HS receiver and a squelch detector.

10. An embedded Universal Serial Bus 2 (eUSB2) circuitry of an apparatus, the eUSB2 circuitry comprising:
a High Speed (HS) receiver to receive user data at a first data rate from a component; and
a Low Speed and/or Full Speed (LS/FS) transceiver to communicate control data with the component at one or both of a second data rate or a third data rate, wherein the second or third data rate is slower than the first data rate,
wherein a Physical Layer (PHY) of the USB circuitry lacks a HS transmitter to transmit data to the component.

11. The eUSB2 circuitry of claim 10, further comprising:
a squelch detector associated with receiving the user data at the first data rate.

12. The eUSB2 circuitry of claim 10, wherein the LS/FS transceiver comprises:
a pair of single ended LS/FS transmitters to transmit control data to the component at one or both of the second data rate or the third data rate; and
a pair of single ended LS/FS receivers to receive control data from the component at one or both of the second data rate or the third data rate.

13. A system comprising:
a memory to store instructions;
a processor to execute the instructions, and to communicate with a component via a Universal Serial Bus (USB) physical layer (PHY); and
the USB PHY, wherein the USB PHY is to receive High Speed (HS) data from the component, and to refrain from transmitting HS data to the component.

14. The system of claim 1, wherein HS data comprises user data communicated at a data rate of about 480 Mega bits per second (Mbit/s) or higher.

15. The system of claim 13, wherein the USB PHY comprises a HS receiver and lacks a HS transmitter.

16. The system of claim 13, wherein the USB PHY is a first USB PHY, and wherein the system comprises:
the component comprising a second USB PHY, wherein the second USB PHY is to transmit the HS data to the first USB PHY, and to refrain from receiving HS data from the first USB PHY.

17. The system of claim 16, wherein the component is a data generation component that generates user data for transmission to the USB PHY.

18. A method comprising:
enumerating, by a component and to a host, itself as a Low Speed (LS) Universal Serial Bus (USB) component;
subsequent to enumerating itself as a LS USB component, establishing, by the component, a LS USB link with the host; and
subsequent to establishing the LS USB link, enumerating, by the component and to the host, itself as an asymmetrical High Speed (HS) embedded Universal Serial Bus (eUSB) component.

19. The method of claim 18, further comprising:
transmitting, by the component and to the host, data using a HS data rate; and
refraining from receiving, by the component and from the host, data using the HS data rate.

20. The method of claim 18, further comprising:
transmitting, by the component and to the host, control data using a LS data rate or a Full Speed (FS) data rate; and
receiving, by the component and from the host, control data using the LS data rate or the FS data rate.
